(19) United States
(12) Patent Application Publication
(10) Pub. No.: US 2026/0079421 A1
(43) Pub. Date: Mar. 19, 2026

(54) IMAGE FORMING APPARATUS

(71) Applicant: CANON KABUSHIKI KAISHA, Tokyo (JP)

(72) Inventor: TOMOHIRO SUZUKI, Chiba (JP)

(21) Appl. No.: 19/323,528

(22) Filed: Sep. 9, 2025

(30) Foreign Application Priority Data
Sep. 13, 2024 (JP) 2024-158770

(51) Int. Cl. G03G 15/01; G03G 15/08; G03G 21/16

(52) U.S. Cl. CPC G03G 15/0121; G03G 15/0189; G03G 15/0875; G03G 21/1619; G03G 21/1647; G03G 2221/1684

(57) ABSTRACT

An image forming apparatus includes a toner container with a discharging port for discharging toner and an apparatus body including a body frame that allows the toner container to be detachably mounted and that has a communication port that communicates with the discharging port. The apparatus body includes a drum unit including a photosensitive drum, a development unit including a developing frame having a receiving inlet to receive the toner and a toner storage portion and a development roller that supplies the toner to the photosensitive drum, and a flexible tube for conveying toner from the communication port to the receiving inlet. The development unit is movable between a contact position where the development roller contacts the photosensitive drum and a separated position where the development roller is separated from the photosensitive drum. The flexible tube bends as the development unit moves between the contact and separated positions.

### BACKGROUND

### Field of the Technology

The present disclosure relates to an electrophotographic image forming apparatus.

### Description of the Related Art

A configuration of an electrophotographic image forming apparatus has been developed in which toner is conveyed from a container having a supply port that allows a toner container to be removably mounted to a developing device by using a toner tube that extends from the container to the developing device (refer to, for example, Japanese Patent Laid-Open No. 2023-7031). The configuration prevents the toner from leaking by providing a sealing member between the toner tube and the developing device. When the developing device moves relative to a photosensitive drum, the sealing member is elastically deformed in accordance with the movement of the developing device and, thus, toner leakage is prevented.

### SUMMARY

An aspect of the present disclosure provides an image forming apparatus that includes a toner container and an apparatus body. The toner container is configured to contain toner. The toner container has a discharging port through which the toner is discharged. The apparatus body includes a body frame configured for detachable mounting of the toner container on the body frame. The body frame has a communication port that communicates with the discharging port. The apparatus body includes a drum unit, including a photosensitive drum, a development unit, and a passage. The drum unit includes a photosensitive drum. The development unit includes a developing frame and a development roller. The developing frame is provided with a receiving inlet for receiving the toner, and the developing frame includes a storage portion that stores the toner. The development roller is configured to bear the toner stored in the storage portion and supply the toner to the photosensitive drum. The development unit is configured to be movable relative to the photosensitive drum and the body frame between a contact position where the development roller is in contact with the photosensitive drum in the drum unit and a separated position where the development roller is separated from the photosensitive drum. The passage is through which the toner discharged from the discharging port of the toner container passes when the toner is conveyed from the communication port to the receiving inlet. The passage has a first end connected to the body frame to communicate with the communication port and a second end connected to the development unit to communicate with the receiving inlet and extends from the first end to the second end. The passage comprises a flexible tube and is configured to bend between the first end and the second end as the development unit is moved between the contact position and the separated position.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to a first embodiment.

FIG. 2A is a perspective view of the image forming apparatus with a front door closed, according to the first embodiment.

FIG. 2B is a perspective view of the image forming apparatus with the front door open, according to the first embodiment.

FIG. 2C is a perspective view of the image forming apparatus with the front door open and with a cartridge removed from a cartridge holder according to the first embodiment.

FIG. 3A is a perspective view of an image forming unit with a cartridge mounted, according to the first embodiment.

FIG. 3B is a perspective view of the image forming unit with the cartridge removed.

FIG. 4A is a top view of a laser scanner unit and the image forming unit according to the first embodiment.

FIG. 4B is a top view of the image forming unit only.

FIG. 5 is a cross-sectional view taken along a line V-V of FIG. 4A.

FIG. 6A is a cross-sectional view taken along a line VIA-VIA of FIG. 4A when the image forming unit in FIG. 4A is in a contact position.

FIG. 6B is a cross-sectional view taken along the line VIB-VIB of FIG. 4A when the image forming unit in FIG. 4A is in a separated position.

FIG. 7A is a front view of a cartridge according to the first embodiment.

FIG. 7B is a top view of the cartridge according to the first embodiment.

FIG. 7C is a bottom view of the cartridge according to the first embodiment.

FIG. 7D is a right side view of the cartridge according to the first embodiment.

FIG. 7E is a back view of the cartridge according to the first embodiment.

FIG. 8A is a cross-sectional view taken along a line VIIIA-VIIIA of FIG. 7E.

FIG. 8B is a perspective view of the cartridge.

FIG. 8C is an exploded perspective view of the cartridge.

FIG. 9A is a cross-sectional view taken along a line IXA-IXA of FIG. 7B.

FIG. 9B is a perspective view of FIG. 9A.

FIG. 10A is a perspective view of the image forming unit that includes a low-friction member and that is in a contact state according to the first embodiment.

FIG. 10B is a top view of the image forming unit that includes the low-friction member and that is in a separated state according to the first embodiment.

FIG. 11A is a cross-sectional view of the image forming unit according to the first embodiment.

FIG. 11B is a perspective view of the low-friction member according to the first embodiment.

FIG. 11C is a front view of the low-friction member according to the first embodiment.

FIG. 12A is a perspective view of an image forming unit that includes a low-friction member and that is in a contact state according to a second embodiment.

FIG. 12B is a perspective view of the image forming unit that includes the low-friction member and that is in a separated state according to the second embodiment.

FIG. 13A is a cross-sectional view of an image forming unit that includes a low-friction member according to the second embodiment.

FIG. 13B is a perspective view of the low-friction member according to the second embodiment.

FIG. 13C is a front view of the low-friction member according to the second embodiment.

FIG. 14A is a perspective view of an image forming unit that includes a low-friction member and that is in a contact state according to a third embodiment.

FIG. 14B is a perspective view of the image forming unit that includes the low-friction member and that is in a separated state according to the third embodiment.

### DESCRIPTION OF THE EMBODIMENTS

### First Embodiment

### Image Forming Apparatus

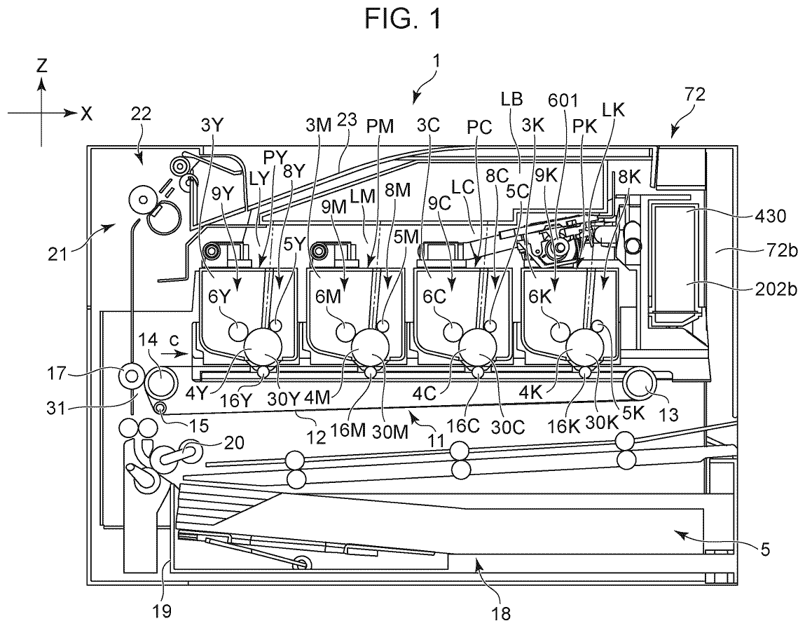

An image forming apparatus 1 according to the first embodiment of the present disclosure is described with reference to FIG. 1. The electrophotographic image forming apparatus according to the present embodiment is a full-color image forming apparatus including four process units for four colors. FIG. 1 is a principal sectional view of the image forming apparatus 1.

The image forming apparatus 1 is a full-color laser printer that uses an electrophotographic process and can form a full-color image on a recording medium S. The image forming apparatus 1 includes a process unit PY (a second process unit), a process unit PM (a first process unit), a process unit PC, and a process unit PK (hereinafter, the units are referred to as “process units P”), and an apparatus body 72. The process units P are arranged to be aligned in a first direction X, and the colors of the toner contained in the process units P are different from one another. The longitudinal direction of each of the process units P is a second direction Y perpendicular to the first direction X.

Each of the process units P has an electrophotographic process element. A rotational driving force is transmitted from a drive output unit of the apparatus body 72, and a bias voltage (a charging bias, developing bias, or the like) is supplied from a bias applying unit of the apparatus body 72 to each of the process units P.

As illustrated in FIG. 1, the process units P include a drum unit 8Y (first drum unit), a drum unit 8M (second drum unit), a drum unit 8C, and a drum unit 8K (hereinafter the drum units are referred to as “drum units 8”), respectively. The drum units 8 include a photosensitive drum 4Y (second photosensitive drum), a photosensitive drum 4M (first photosensitive drum), a photosensitive drum 4C, and a photosensitive drum 4K (hereinafter the photosensitive drums are referred to as “photosensitive drums 4”), respectively. The drum units 8 further include charging rollers 5Y, 5M, 5C, and 5K (hereinafter the charging rollers are referred to as “charging rollers 5”) that serve process units acting on the photosensitive drums 4, respectively. Each of the photosensitive drums 4 is disposed so that the direction of its rotational axis is the second direction Y.

The process units P include development units 9Y (second development unit), 9M (first development unit), 9C, and 9K (hereinafter referred to as “development units 9”), respectively. The development units 9 include a development roller 6Y (second development roller), a development roller 6M (first development roller), a development roller 6C, and a development roller 6K (hereinafter referred to as “development rollers 6”) that develop electrostatic latent images on the corresponding photosensitive drums 4, respectively. The development units 9 are aligned in the first direction X.

The development units 9 include developer containers 3Y (a second storage portion, a second developing frame), 3M (a first storage portion, a first developing frame), 3C, and 3K (hereinafter referred to as “developer containers 3”), respectively. The development unit 9Y includes the developer container 3Y (the second developer container) that contains yellow color (Y) toner (second toner) and is configured such that the yellow color (Y) toner is supplied to the surface of the photosensitive drum 4Y by the development roller 6Y that bears the yellow color (Y) toner. The development unit 9M includes the developer container 3M (the first developer container) that contains magenta color (M) toner (first toner) and is configured such that the magenta color (M) toner is supplied to the surface of the photosensitive drum 4M by the development roller 6M that bears the magenta color (M) toner. The development unit 9C includes the developer container 3C that contains cyan color (C) toner (third toner) and is configured such that cyan color (C) toner is supplied to the surface of the photosensitive drum 4C by the development roller 6C that bears cyan color (C) toner. The development unit 9K includes the developer container 3K that contains black color (K) toner (fourth toner) and is configured such that the black color (K) toner is supplied to the surface of the photosensitive drum 4K by the development roller 6K that bears the black color (K) toner.

In a third direction Z that intersects both the first direction X and the second direction Y, a laser scanner unit LB (an exposure unit) is provided above the process units P (the photosensitive drums 4). The laser scanner unit LB outputs a laser beam corresponding to image information. Hereinafter, LY, LM, LC, and LK denote the optical paths of the laser beams directed to the photosensitive drums 4Y, 4M, 4C, and 4K, respectively (with the optical paths being referred to as “optical paths L”). The laser beam then scans to expose the surface of each of the photosensitive drums 4. Instead of the laser scanner unit LB, an LED exposure unit may be used.

Below the process units P in the third direction Z, an intermediate transfer belt unit 11 is provided as a transfer member. The intermediate transfer belt unit 11 includes a drive roller 14, a tension roller 13, and an assist roller 15, about which a flexible transfer belt 12 is entrained.

The lower surface of each of the photosensitive drums 4 is in contact with the upper surface of the transfer belt 12. The contact portion between the transfer belt 12 and each of the photosensitive drums 4 serves as a primary transfer unit 30Y, 30M, 30C, or 30K (hereinafter the primary transfer units are referred to as “primary transfer units 30”). Inside of the transfer belt 12, primary transfer rollers 16Y, 16M, 16C, and 16K (hereinafter referred to as “transfer rollers 16”) are provided, each facing the corresponding one of the photosensitive drums 4.

A secondary transfer roller 17 is pressed against the drive roller 14 via the transfer belt 12. A contact portion between the transfer belt 12 and the secondary transfer roller 17 serves as a secondary transfer unit 31.

A feeding unit 18 is provided below the intermediate transfer belt unit 11 in the third direction Z. The feeding unit 18 includes a paper feed tray 19 that loads and stores the recording medium S and a paper feeding roller 20 that picks up and conveys the recording medium S from the paper feed tray 19.

The upper part of the apparatus body 72 illustrated in FIG. 1 includes a fixing unit 21 that fixes the toner image to the recording medium S and a discharge roller 22 that discharges the recording medium S having the toner image fixed thereon to an output tray 23. The discharge roller 22 discharges the recording medium S in a direction along the first direction X. According to the present embodiment, the downstream side of a discharge direction in which the recording medium S is discharged by the discharge roller 22 toward the output tray 23 is the front side of the image forming apparatus 1, and the upstream side of the discharge direction is the back side of the image forming apparatus 1.

### Image Forming Operation

The operation for forming a full-color image is described below. Each of the photosensitive drums 4 is driven to rotate counterclockwise at a predetermined speed in FIG. 1. The transfer belt 12 is rotationally driven at a speed corresponding to the rotational speed of the photosensitive drum 4 in a forward direction of the rotation of the photosensitive drum 4.

The laser scanner unit LB is also driven. In each of the process units P, the charging roller 5 uniformly charges the surface of the corresponding photosensitive drum 4 to a predetermined polarity and a predetermined potential in synchronization with the driving of the laser scanner unit LB. The laser scanner unit LB scans to expose the surface of the charged photosensitive drum 4 with a laser beam L in accordance with an image signal of each color, and an electrostatic latent image is formed on the surface of the photosensitive drum 4 in accordance with the image signal of each color. That is, the laser scanner unit LB exposes the photosensitive drums 4Y and 4M to form first and second electrostatic latent images on the photosensitive drums 4Y and 4M, respectively. Similarly, the laser scanner unit LB exposes the photosensitive drums 4C and 4K to form third and fourth electrostatic latent images on the photosensitive drums 4C and 4K, respectively.

The electrostatic latent image on each of the photosensitive drums 4 is developed by supplying toner to the photosensitive drum 4 by the corresponding one of the development rollers 6, which is driven to rotate clockwise in FIG. 1 at a predetermined speed. Through the electrophotographic image forming process described above, a yellow toner image is formed on the photosensitive drum 4Y of the process unit PY. The yellow toner image is then primary transferred onto the transfer belt 12. Similarly, a magenta toner image is formed on the photosensitive drum 4M of the process unit PM. The magenta toner image is then primary transferred onto the transfer belt 12 so as to be superimposed on the yellow toner image on the transfer belt 12. A cyan toner image is formed on the photosensitive drum 4C of the process unit PC. The cyan toner image is then primary transferred onto the transfer belt 12 so as to be superimposed on the yellow and magenta toner images on the transfer belt 12. A black toner image is formed on the photosensitive drum 4K of the process unit PK. The black toner image is then primary transferred onto the transfer belt 12 so as to be superimposed on the yellow, magenta, and cyan toner images on the transfer belt 12.

In this way, four-color printing full-color unfixed toner images of yellow, magenta, cyan, and black are formed on the transfer belt 12. At a predetermined control timing, one of the recording media S is separated from the stack on the paper feed tray 19 and is fed by the paper feeding roller 20. The recording medium S is conveyed into the secondary transfer unit 31, which is the contact portion between the secondary transfer roller 17 and the transfer belt 12, at a predetermined control timing. In the process of conveying the recording medium S in the secondary transfer unit 31, the superimposed toner images of four colors on the transfer belt 12 are transferred to the recording medium S. The recording medium S having the toner images transferred thereon is heated and pressurized by the fixing unit 21 to fix the toner images on the recording medium S. The recording medium S having the toner images fixed thereon is discharged by the discharge roller 22 to the output tray 23.

### Arrangement and Mount/Dismount of Cartridges

The image forming apparatus 1 includes a cartridge 430Y (a second cartridge, a second toner container), a cartridge 430M (a first cartridge, a first toner container), a cartridge 430C, and a cartridge 430K (hereinafter referred to “cartridges 430”) that are resupply containers removable from the apparatus body 72. The cartridges 430 are aligned in the second direction Y. That is, the cartridges 430 are aligned in a direction that intersects (is orthogonal to) the direction in which the development units 9 are aligned.

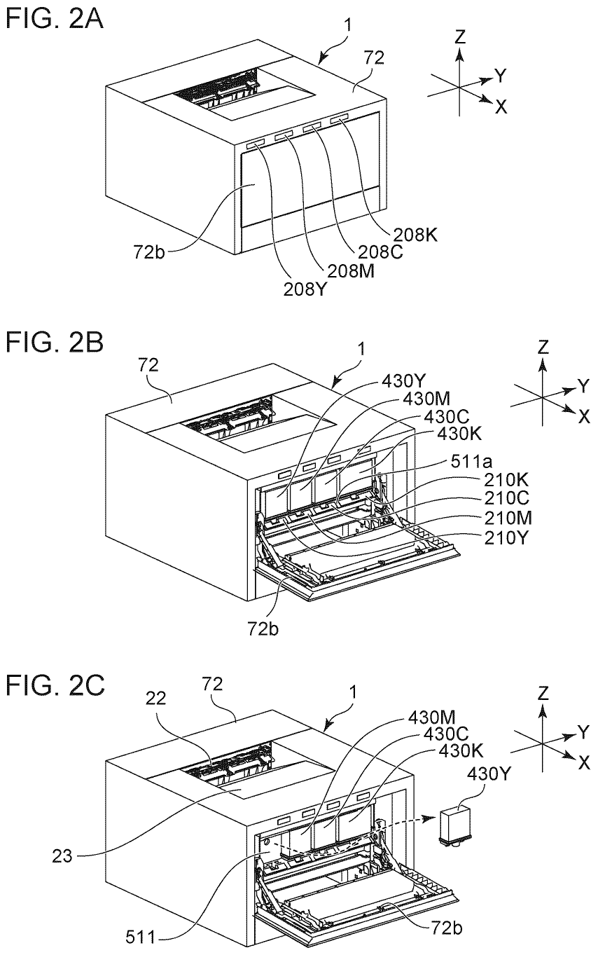

FIG. 2A is a perspective view of the image forming apparatus 1 with a front door 72b closed. FIG. 2B is a perspective view of the image forming apparatus 1 with the front door 72b open. FIG. 2C is a perspective view of the image forming apparatus 1 with the front door 72b open and with the cartridge 430Y removed from a cartridge holder 511. The cartridge holder 511 is a mounting portion (part of a body frame) that allows the cartridge 430 to be mounted thereon and removed therefrom.

Each of the cartridges 430 is mounted on the upper front side of the apparatus body 72 so as to be accessed by opening the front door 72b. That is, each of the cartridges 430 is located at an end portion of the apparatus body 72 on the downstream side in the discharge direction of the discharge roller 22. The front door 72b is configured to be movable between a closed position (refer to FIG. 2A) where an opening of the apparatus body 72 on the front side is closed and an open position (refer to FIG. 2B) where the opening is open. When the front door 72b is moved to the open position, the cartridges 430 are exposed to the outside of the image forming apparatus 1 through the opening, as illustrated in FIG. 2B. The cartridges 430 are arranged to be aligned in the second direction Y and are configured to be removable from the apparatus body 72 in the first direction X, as illustrated in FIG. 2C. This configuration allows toner to be resupplied into each of the process units P without dismounting the process unit P from the apparatus body 72.

The cartridges 430 are disposed on the front side of the image forming apparatus 1 and, thus, the cartridges 430 are accessible from the front side, as in the case where the recording medium S discharged onto the output tray 23 is collected. In addition, because the cartridge holder 511 is located on the front side of the image forming apparatus 1, the process unit P is not exposed after the cartridge 430 is removed (refer to FIG. 2C). The cartridges 430 are housed inside of the apparatus body 72 when the front door 72b is closed.

As illustrated in FIG. 2A, indicators 208Y, 208M, 208C, and 208K (hereinafter referred to as “indicators 208”) (an indicating portion, a displaying portion) for the colors are provided on the front side of the image forming apparatus 1. The indicators 208 are aligned in the second direction Y so as to correspond to the cartridges 430, respectively. The indicator 208Y is yellow colored, the indicator 208M is magenta colored, the indicator 208C is cyan colored, and the indicator 208K is black colored. Each of the indicators 208 is composed of an LED or a sticker having a color corresponding to the color of the toner in the corresponding cartridge 430 in order to prevent mis-mounting of the cartridges 430. The indicators 208 may also have a function to display the remaining toner levels of the corresponding process units P (the corresponding development units 9).

As illustrated in FIG. 2B, the lower part of the cartridge holder 511 has a sloping portion 511a. The sloping portion 511a is a surface sloped diagonally upward toward the body frame and has, attached thereto, a label 210 corresponding to the toner color of the cartridge. The user can view the label 210 on the sloping portion 511a when replacing the cartridge, so that the cartridge 430 can be mounted in place.

### Image Forming Unit

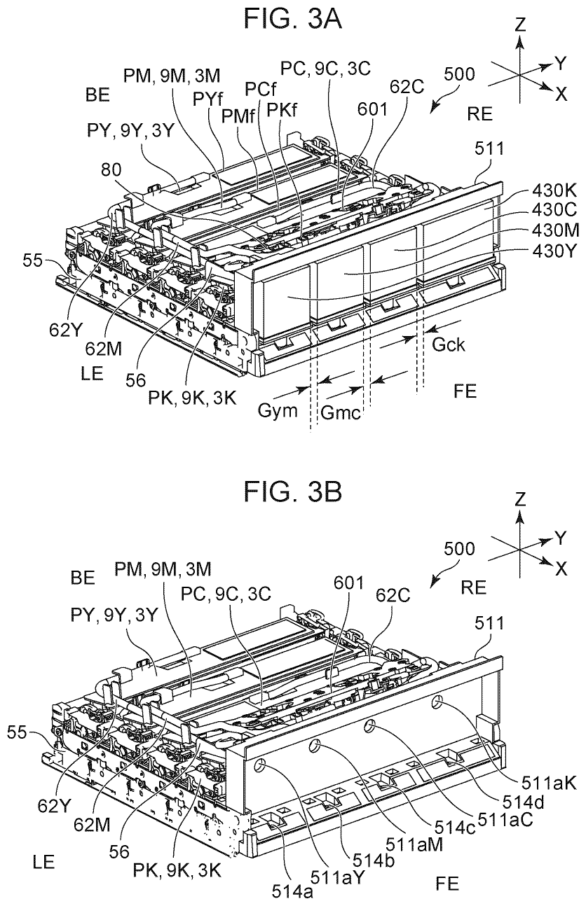

A toner conveyance mechanism from each of the cartridges 430 to the corresponding process unit P is described below with reference to FIG. 3A to FIG. 5.

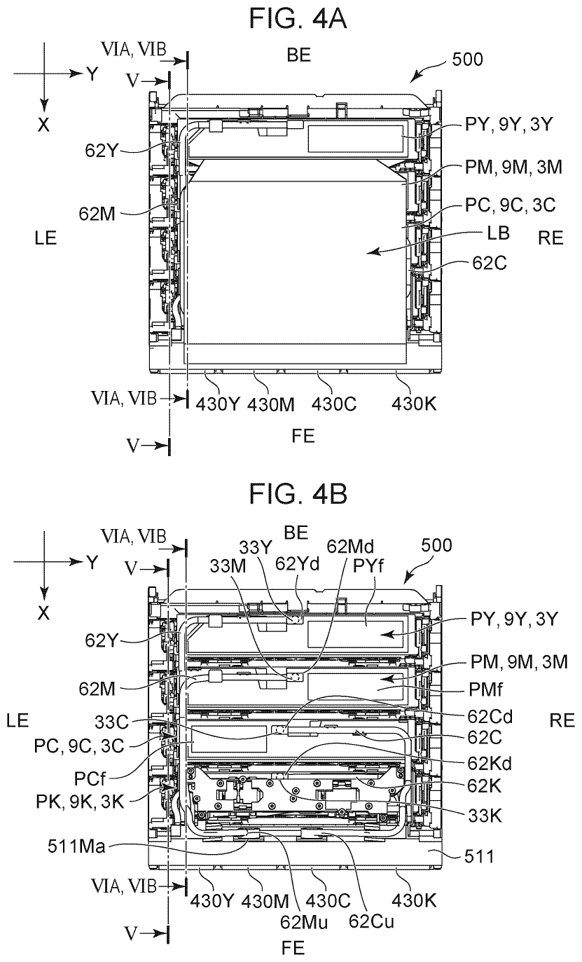

A unit that includes the cartridges 430, the process units P, and conveyance paths each conveying toner from one of the cartridges 430 to the corresponding process unit P (described below) is referred to as an “image forming unit 500”. FIG. 3A is a perspective view of the image forming unit 500 with the cartridges 430 mounted. FIG. 3B is a perspective view of the image forming unit with the cartridges 430 removed. FIG. 4A is a top view of the laser scanner unit LB and the image forming unit 500. FIG. 4B is a top view of the image forming unit 500 only.

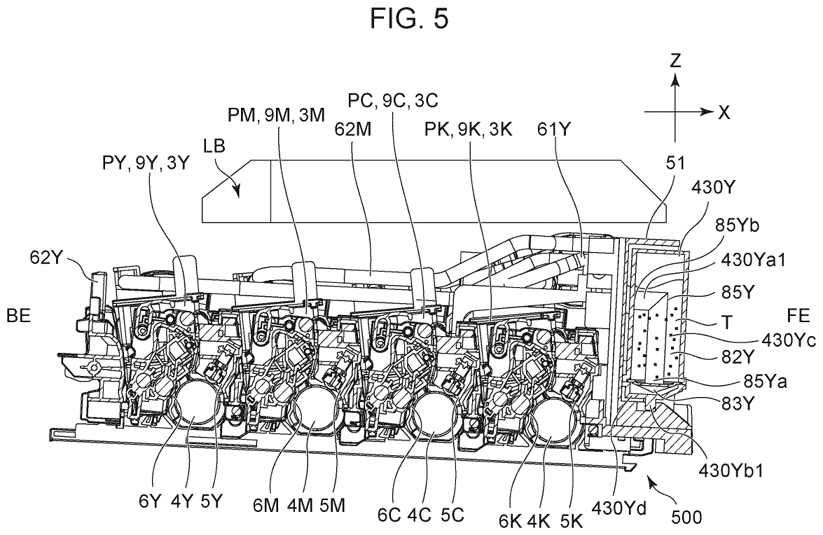

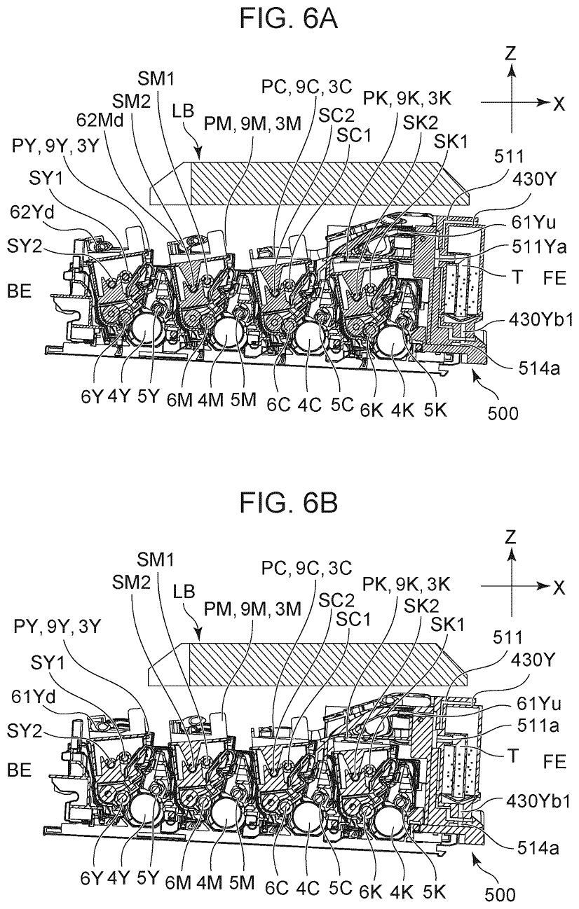

FIG. 5 is a cross-sectional view taken along a line V-V of FIG. 4A. FIG. 6A is a cross-sectional view taken along a line VIA-VIA of FIG. 4A when the image forming unit 500 in FIG. 4A is in a contact state. FIG. 6B is a cross-sectional view taken along the line VIB-VIB of FIG. 4A when the image forming unit 500 in FIG. 4A is in a separated state.

As illustrated in FIG. 3A, the image forming unit 500 is disposed so that the process units P (PY, PM, PC, PK) are aligned in the first direction X. The process units P are mounted on a tray 55. The cartridge holder 511 is disposed at the front of the tray 55. The cartridges 430 are mounted on the cartridge holder 511. The cartridges 430 are arranged so as to be aligned in the second direction Y.

The pump unit 80 is provided above the process unit PK. The pump unit 80 is supported by a support member 56 and is attached to the cartridge holder 511.

The pump unit 80 consists of four pumps each pumping air to one of the cartridges 430. The pump are displacement pumps, such as reciprocating pumps or rotary pumps. Reciprocating pumps are pumps that suck and discharge by reciprocating pistons or plungers. Examples of a reciprocating pump include a piston pump, a plunger pump, and a diaphragm pump. Rotary pumps are pumps that suck and discharge by rotating gears or rotors. Examples of a rotary pump include a gear pump, a screw pump, and a vane pump. According to the present embodiment, the pump unit 80 is provided in the image forming unit 500. However, the pump unit 80 may be provided in each of the cartridges 430 or in the apparatus body 72.

### Supply of Air From Air Supply Port to Cartridge

As illustrated in FIG. 3B and FIG. 5, a portion of the cartridge holder 511 facing the lower surface of each of the cartridges 430 has openings to expose air supply ports 514a, 514b, 514c, and 514d (hereinafter referred to “air supply ports 514”) provided by the pump unit 80. The air supply ports 514 open upward.

Air discharged from each of the air supply ports 514 upward is supplied to the inside of the cartridge 430 mounted on the cartridge holder 511. The air supplied to the inside of the cartridge 430 is discharged together with toner from the cartridge 430 to the outside. The internal structure of the cartridge 430 is described below.

The toner discharged together with air from the cartridges 430 is received by tubes (toner conveyance tubes) 62Y, 62M, 62C, and 62K (hereinafter referred to as “tubes 62”) through receiving inlets 511aY (a second communication port), 511aM (first communication port), 511aC, and 511aK (hereinafter collectively referred to as “receiving inlets 511a”) provided in the cartridge holder 511 illustrated in FIG. 3B, respectively. Each of the receiving inlets 511a is a through-hole that passes through the surface of the cartridge holder 511 facing the back surface of the cartridge 430. Each of the tubes 62 extends to one of the development units 9 and is connected to the development unit 9. Each of the receiving inlets 511a opens in the first direction X in which the development units 9 are aligned. The direction in which each of the receiving inlets 511a opens intersects the direction in which each of the air supply ports 514 opens.

The toner received through the receiving inlets 511a is moved from upstream ends 62u to downstream ends 62d (62Yd, 62Md, 62Cd, 62Kd) by the air discharged from the cartridges 430 through the inside of the tubes 62 and is resupplied to the development units 9, respectively.

The toner receiving inlets 33 (33Y, 33M, 33C, 33K) are provided on the top surfaces of the developer containers 3, respectively. The developer containers 3 are the storage portions of the development units 9 that contain toner T. The toner T is resupplied to each of the developer containers 3 together with air through the corresponding one of the toner receiving inlets 33.

For the image forming unit 500 to have a configuration to enable easy access to the process unit P and the tube 62 for maintenance and replacement of the process unit P, the tube 62, and the like in case of failure. For this reason, according to the present embodiment, the configuration is such that the image forming unit 500 can be pulled out from the BE side (back side) to the FE side (front side) of the apparatus body 72 (the intermediate transfer belt unit 11).

### Structure of Cartridge

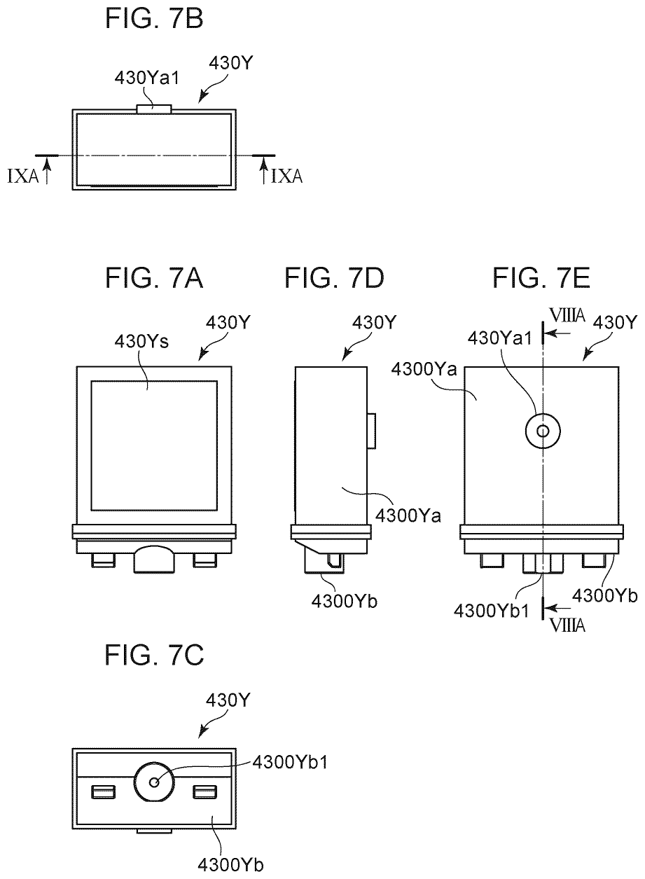

The structure of each of the cartridges 430 (the toner containers) according to the present embodiment is described below with reference to FIGS. 7A to 9B. The structures of the cartridges 430 are all the same. Therefore, the structure of the cartridge 430Y is described below. FIGS. 7A, 7B, 7C, 7D, and 7E are the front, top, bottom, right side, and back views of the cartridge 430Y, respectively.

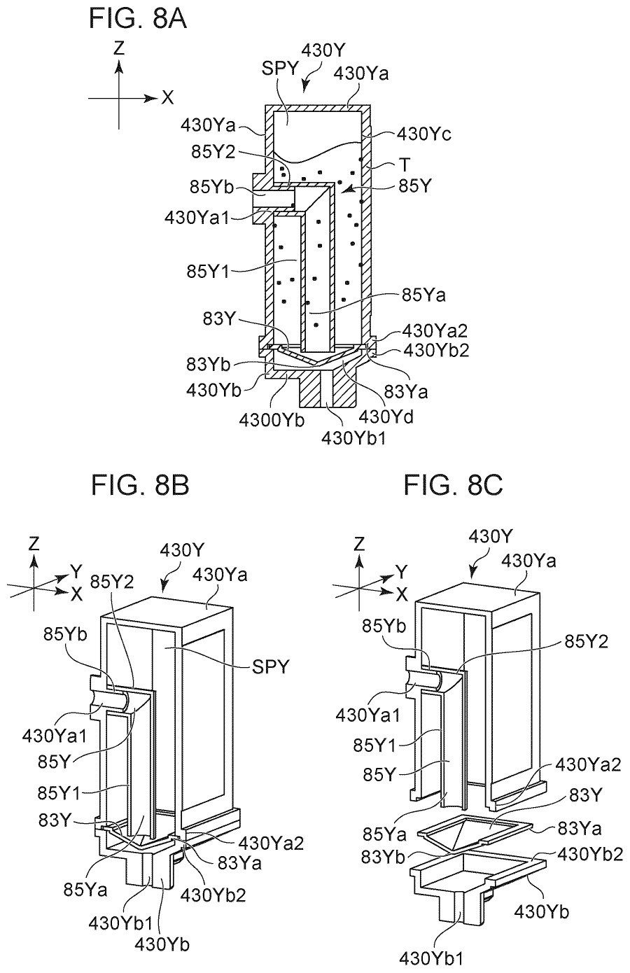

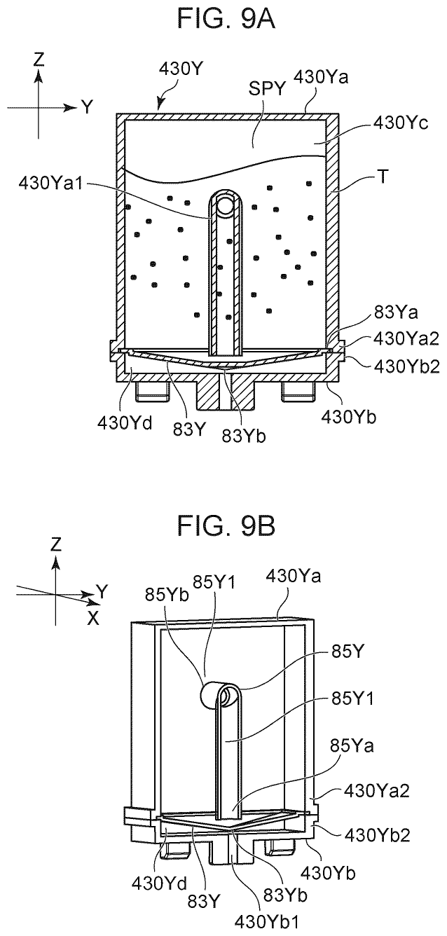

FIG. 8A is a cross-sectional view taken along a line VIIIA-VIIIA of FIG. 7E. FIG. 8B is a perspective view of the cartridge 430Y. FIG. 8C is an exploded perspective view of the cartridge 430Y. FIG. 9A is a cross-sectional view taken along a line IXA-IXA of FIG. 7B. FIG. 9B is a perspective view of FIG. 9A. The structure of the cartridge 430Y mounted in the cartridge holder 511 is described below.

As illustrated in FIGS. 8A to 8C, the cartridge 430Y includes a first frame 430Ya, a second frame 430Yb, a filter 83Y (a first filter, a first ventilation member), and a discharge pipe 85Y (a first discharge pipe, a first passage). Similarly, the cartridge 430M includes a third frame, a fourth frame, a filter (a second filter, a second ventilation member), and a discharge pipe (a second discharge pipe, a second passage). Similarly, the cartridge 430C includes a fifth frame, a sixth frame, a filter (a third filter, a third ventilation member), and a discharge pipe (a third discharge pipe, a third passage). Similarly, the cartridge 430K includes a seventh frame, an eighth frame, a filter (a fourth filter, a fourth ventilation member), and a discharge pipe (a fourth discharge pipe, a fourth passage).

According to the present embodiment, the first frame 430Ya and the second frame 430Yb are molded resin members. However, the first frame 430Ya and the second frame 430Yb may be made of paper or the like. As illustrated in FIG. 7E, a discharging port 430Ya1 (a first discharging port) is provided on a back surface 4300Ya of the first frame 430Ya. As illustrated in FIG. 7C, a receiving inlet 430Yb1 (a first receiving inlet, a first intake) is provided on a bottom surface 4300Yb of the second frame 430Yb. The discharging port 430Ya1 and the receiving inlet 430Yb1 are provided on the surface of the cartridge 430Y except for the surface that intersects the second direction Y, which is the direction in which the cartridges 430 are aligned, (the surface facing the second direction Y). This configuration can reduce the gap G (Gym, Gmc, Gck) between two of the cartridges 430 illustrated in FIG. 3A. As a result, the width L of each of the cartridges 430 can be increased, thus increasing the toner storage volume of the cartridge 430. The gap Gym is the gap between the cartridges 430Y and 430M in the second direction Y. The gap Gmc is the gap between the cartridges 430M and 430C in the second direction Y. The gap Gck is the gap in the second direction Y between cartridges 430C and 430K.

The discharging port 430Ya1 is provided on the back surface 4300Ya of the cartridge 430Y (the end surface of the cartridge 430Y on the downstream side in the mounting direction) so as to be open downstream in the mounting direction. For this reason, when the cartridge 430Y is mounted in the cartridge holder 511, the discharging port 430Ya1 can be easily engaged with a receiving inlet 429Ya of the cartridge holder 511 to communicate with the receiving inlet 429Ya. The discharging port 430Ya1 may be provided on the bottom surface 4300Yb or top surface of the cartridge 430Y, and the receiving inlet 430Yb1 may be provided on the back surface 4300Ya or top surface. If there is enough space in the apparatus body 72, the discharging port 430Ya1 and the receiving inlet 430Yb1 may be provided on a surface that intersects the second direction Y. Similarly, the cartridge 430M has a discharging port (a second discharging port) and a receiving inlet (a second receiving inlet, a second intake) disposed in the same manner as in the cartridge 430Y. The cartridge 430C has a discharging port (a third discharging port) and a receiving inlet (a third receiving inlet, a third intake) disposed in the same manner as in the cartridge 430Y. The cartridge 430K has a discharging port (a fourth discharging port) and a receiving inlet (a fourth receiving inlet, a fourth intake) disposed in the same manner as in the cartridge 430Y.

A sealing member (a seal or shutter) (not illustrated) may be provided at the discharging port 430Ya1. When the cartridge 430Y is not mounted in the cartridge holder 511 of the apparatus body 72, the sealing member seals the discharging port 430Ya1 to prevent the toner T contained inside of the cartridge 430Y from leaking outside. When the cartridge 430Y is mounted in the cartridge holder 511, the sealing member is removed or moved so that the discharging port 430Ya1 is open.

The label 430Ys on the front surface of the cartridge 430Y illustrated in FIG. 7A is intended to indicate the color of the toner inside of the cartridge 430Y. The label 430Ys may also indicate an illustrated instruction describing how the cartridge 430Y is mounted in the cartridge holder 511 or may be a label displaying some information about the cartridge 430Y.

The first frame 430Ya and the second frame 430Yb have a flange portion 430Ya2 and a flange portion 430Yb2, respectively. The flange portions 430Ya2 and 430Yb2 are welded to each other by ultrasonic welding to form an inner space SPY of the cartridge 430Y illustrated in FIG. 8A. The flange portions 430Ya2 and 430Yb2 may be secured to each other by an adhesive or a screw.

The filter 83Y is provided to partition (divide) the inner space SPY of cartridge 430Y into two parts: a toner chamber 430Yc (a first chamber) and an air chamber 430Yd (a second chamber). That is, the air chamber 430Yd is adjacent to the toner chamber 430Yc via the filter 83Y. A filter is provided to partition (divide) an inner space SPM of the cartridge 430M into two parts: a toner chamber (a third chamber) and an air chamber (a fourth chamber). That is, the air chamber is adjacent to the toner chamber via the filter. The filter is provided to partition (divide) an inner space of the cartridge 430C into two parts: a toner chamber (a fifth chamber) and an air chamber (a sixth chamber). That is, the air chamber is adjacent to the toner chamber via the filter 83C. The filter is provided to partition (divide) an inner space of the cartridge 430K into two parts: a toner chamber (a seventh chamber) and an air chamber (an eighth chamber). That is, the air chamber is adjacent to the toner chamber via the filter.

The toner chamber 430Yc is located above the air chamber 430Yd and is aligned with air chamber 430Yd in the third direction Z. That is, the cartridge 430Y is mounted in the apparatus body 72 such that the toner chamber 430Yc is located above the air chamber 430Yd. The alignment direction in which the toner chamber 430Yc and the air chamber 430Yd are aligned is the third direction Z. Therefore, according to the present embodiment, the receiving inlet 430Yb1 is open in the alignment direction, and the discharging port 430Ya1 is open in a direction that intersects the alignment direction.

The toner chamber 430Yc is configured to contain the toner T. In the toner chamber 430Yc, the toner T is supported by the filter 83Y.

The air chamber 430Yd does not contain toner. The filter 83Y is composed of a porous member made of resin fibers, for example, and has pores of a size and density that allows air to pass therethrough but prevents the transfer of toner. That is, the filter 83Y is configured to allow air to pass therethrough but prevent the transfer of toner. As illustrated in FIGS. 7A to 7E and FIGS. 8A to 8C, an outer edge portion 83Ya of the filter 83Y is sandwiched between the flange portion 430Ya2 of the first frame 430Ya and the flange portion 430Yb2 of the second frame 430Yb and is held by the first frame 430Ya and the second frame 430Yb. The filter 83Y is inclined from the outer edge portion 83Ya toward a lowermost portion 83Yb, which is lower than the outer edge portion 83Ya. That is, the filter 83Y has a portion (a sloping portion) that slopes downward toward (closer to) the lowermost portion 83Yb in the first direction X, the second direction Y, or the horizontal direction.

The lowermost portion 83Yb is a portion protruding from the outer edge portion 83Ya in a direction from the toner chamber 430Yc to the air chamber 430Yd. As illustrated in FIGS. 8A and 9B, the lowermost portion 83Yb is provided at the center of the filter 83Y in the first direction X and the second direction Y. As the filter 83Y, a filter that is molded into the shape described above is used.

The discharge pipe 85Y (a passage) is provided in the toner chamber 430Yc. According to the present embodiment, the discharge pipe 85Y is a molded resin member. However, the discharge pipe 85Y may be made of paper or rubber. The discharge pipe 85Y is a pipe having an inlet 85Ya (a first opening) and an outlet 85Yb (a second opening) and extending from the inlet 85Ya to the outlet 85Yb. The discharge pipe 85Y is a passage that allows the toner T contained in the toner chamber 430Yc to pass therethrough when the toner T is moved toward the discharging port 430Ya1. The discharge pipe 85Y has a first portion 85Y1 having the inlet 85Ya and extending in the third direction Z and a second portion 85Y2 having the outlet 85Yb and extending in the first direction X.

The direction in which the first portion 85Y1 extends and the direction in which the second portion 85Y2 extends intersect (orthogonally) with each other. The outlet 85Yb of the discharge pipe 85Y is connected to the discharging port 430Ya1 so as to communicate with each other. The inlet 85Ya of the discharge pipe 85Y is disposed to face the lowermost portion 83Yb, which is part of the filter 83Y, with a gap therebetween. The inlet 85Ya is in close proximity to the filter 83Y. When the amount of toner T remaining in the toner chamber 430Yc is low, the toner T fluidized by the air received from the receiving inlet 430Yb1 moves along the slope of the filter 83Y described above and collects at the lowermost portion 83Yb. The inlet 85Ya of the discharge pipe 85Y can guide the toner T that collected at the lowermost portion 83Yb of the filter 83Y to the discharging port 430Ya1. This allows the toner T to be efficiently discharged to the outside of the cartridge 430Y even when the amount of toner T remaining in the toner chamber 430Yc of the cartridge 430Y is low.

The cartridge according to the present embodiment has a structure that discharges toner to the outside of the cartridge by air, and there is no need to provide a rotary member, such as a screw. Therefore, a cartridge can be made with a simple structure that requires fewer parts.

### Toner Conveyance Mechanism

A mechanism by which the toner contained in the toner chamber 430Yc of the cartridge 430Y is conveyed to the process unit PY is described below.

The air discharged from the pump unit 80 is supplied from an air supply tube 61Yu to the air supply port 514 via a flow path in the cartridge holder 511. As illustrated in FIG. 5, the air is received from the air supply port 514 into the air chamber 430Yd through the receiving inlet 430Yb1 of the cartridge 430Y. The air then increases the air pressure in the air chamber 430Yd, passes through the filter 83Y, and flows into the toner chamber 430Yc. The air that flows into the toner chamber 430Yc enters between the particles of the toner T and fluidizes the toner T. The fluidized toner T mixed with air is moved in the discharge pipe 85Y from the inlet 85Ya to the outlet 85Yb by the air received into the air chamber 430Yd through the receiving inlet 430Yb1 and is discharged from the discharging port 430Ya1 to the outside of the cartridge 430Y.

As in the present embodiment, by providing the air chamber 430Yd, which is a tightly sealed space, between the pump unit 80 and the filter 83Y, the air discharged from the discharge outlet 80Ya efficiently flows to the filter 83Y without being dispersed to the outside of the cartridge 430Y. For example, the case is discussed where the cartridge 430Y is subjected to vibration or is left unattended for a long period of time, which causes the toner T in the toner chamber 430Yc to agglomerate, and, thus, the pressure required for air to pass through the filter 83Y and flows into the cartridge 430Y is high. In this case, by continuously sending air from the pump unit 80 to the air chamber 430Yd to increase the pressure (atmospheric pressure) in the air chamber 430Yd, it is possible to send air into the toner chamber 430Yc through the filter 83Y. In addition, by providing the air chamber 430Yd, the pump unit 80 need only have a performance level to be able to generate a pressure to continuously send air into the air chamber 430Yd until the pressure reaches a value sufficient for the air to flow from the filter 83Y into the toner chamber 430Yc. Therefore, no special requirements are placed on the air discharge speed and volume. Therefore, a compact pump unit can be employed, which reduces the size of the apparatus.

The tube 62Y (the second tube) is provided for the toner conveyed by air from the cartridge 430Y to the development unit 9Y to pass through. Similarly, the tube 62M (the first tube) is provided for the toner conveyed by air from the cartridge 430M to the corresponding development unit 9M to pass through. The tubes 62C and 62K are also provided for similar purpose. The tubes 62Y, 62M, 62C, and 62K are flexible tubes formed of polyurethane, silicone, nylon, polyolefin, or the like that has excellent flexibility and toner resistance.

The tube 62Y has an upstream end 62Yu (a third end) attached to the cartridge holder 511 and the downstream end 62Yd (a fourth end) attached to the development unit 9. The toner T discharged from the discharging port 430Ya1 of the cartridge 430Y enters the inside of the tube 62Y from the upstream end 62Yu through the receiving inlet 511a of the cartridge holder 511, as illustrated in FIG. 5. The toner T that enters the inside of the tube 62Y from the upstream end 62Yu is conveyed to the downstream end 62Yd by the air that is discharged, together with the toner T, from the discharging port 430Ya1 of the cartridge 430Y and flows into the upstream end 62Yu.

To improve the discharge performance of air to the outside of the development unit 9Y, an exhaust filter portion PYf is provided on the top surface of the development unit 9Y, as illustrated in FIGS. 3A and 3B. The exhaust filter portion PYf is a portion in which a through-hole is provided in the frame that forms the development unit 9Y, and a filter, such as a non-woven fabric filter, is provided in the through-hole. The toner T that flows into the inside of the development unit 9Y from the tube 62Y remains in the development unit 9Y (the developer container 3Y), and at least part of the air is discharged to the outside of the development unit 9Y from the exhaust filter portion PYf. This configuration further prevents the increase in internal pressure inside of the development unit 9Y and, thus, facilitates the toner T and air to flow into the development unit 9Y from the cartridge 430Y via the tube 62Y.

According to the present embodiment, the exhaust filter portion PYf is provided on the top surface of the development unit 9Y located on the downstream side of the toner inflow direction in the second direction Y. The exhaust filter may be installed on a side surface of the development unit 9Y instead of the top surface of the development unit 9Y.

The toner supplied into the development unit 9Y (the developer container 3Y) from an end of the development unit 9Y in the second direction Y is agitated by agitating members SY1 and SY2 illustrated in FIG. 6B to ensure the disperse uniformity. The agitating members SY1 and SY2 may be screws configured to convey the toner T from the end of development unit 9Y on the side to which the downstream end 62Yd of tube 62Y is connected to the end of development unit 9Y on the opposite side in the second direction Y. There may be one agitator member in the development unit 9Y, or two or more, depending on the required agitation efficiency of the toner T in the development unit 9Y.

In the case of a configuration in which, like the tubes 62 according to the present embodiment, the direction of the conveyance path changes in the middle or the conveyance path differs for each color, air is to be employed for conveying the toner. This improves the degree of freedom in designing the conveyance path as compared with employing a screw or the like for conveying the toner. In addition, since a conveyance member is not required, the number of parts can be reduced.

### Tube Structure

The configuration of each of the tubes 62 is described below. The tube 62 is disposed so as to circumvent a path L of light output from the laser scanner unit LB and reduce the conveyance path in accordance with the positions of the development unit 9 and the cartridge 430. As described above, the development unit 9Y is configured to be movable relative to the drum unit 8Y between a contact position where the development roller 6Y is in contact with the photosensitive drum 4Y and a separated position where the development roller 6Y is separated from the photosensitive drum 4Y. As illustrated in FIG. 4B and FIG. 6A, the upstream end 62Yu (third end) of the tube 62Y is attached to the cartridge holder 511 so as to communicate with the receiving inlet 511Ya, and the downstream end 62Yd (fourth end) of the tube 62Y is attached to the top of the development unit 9Y (the developer container 3Y) so as to communicate with the receiving inlet 33Y of the developer container 3Y.

Similarly, as illustrated in FIG. 4B, the upstream end 62Mu (first end) of the tube 62M is attached to the cartridge holder 511 so as to communicate with the receiving inlet 511Ma, and the downstream end 62Md (second end) of tube 62M is attached to the top of the development unit 9M (the developer container 3M) so as to communicate with the receiving inlet 33M of the developer container 3M.

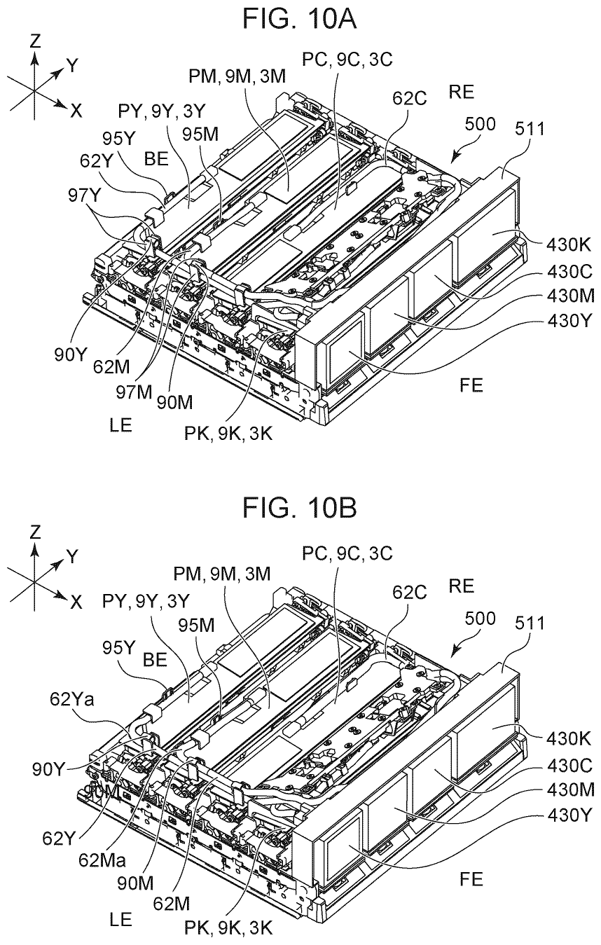

FIGS. 6A and 10A are, respectively, a cross-sectional view (perpendicular to the second direction Y) and a perspective view of the image forming unit 500 in the contact state in which each of the photosensitive drums 4 is in contact with the corresponding one of the development rollers 6. In this contact state, the development unit 9Y (the first development unit) is at the contact position (a first contact position), and the development unit 9M (the second development unit) is in the contact position (a second contact position). In this state, the development unit 9C and development unit 9K are also in the contact state. FIGS. 6B and 10B are, respectively, a cross-sectional view and a perspective view illustrating the separated state in which each of the development units 9 has moved (pivoted) from the contact position in FIG. 10A in the direction closer to the corresponding one of the cartridges 430 in the second direction (a separation direction, +X direction). In this state, the development unit 9Y (the first development unit) is at the separated position (the first separated position), and the development unit 9M (the second development unit) is in the separated position (the second separated position). In this separated state, the development unit 9C and the development unit 9K are also in the separated state.

As the development unit 9Y moves from the contact position to the separated position, the top of the development unit 9Y moves closer to the cartridge holder 511 and, thus, the distance in the first direction X between the top of the development unit 9Y and the cartridge holder 511 decreases. Accordingly, the tube 62Y moves relative to the development unit 9Y in the first direction X, and a bent portion 62Ya is formed, as illustrated in FIG. 10B. As the development unit 9M moves from the contact position to the separated position, the top of the development unit 9M moves closer to the cartridge holder 511 and, thus, the distance in the first direction X between the top of the development unit 9M and the cartridge holder 511 decreases. Accordingly, the tube 62M moves relative to the development unit 9M in the first direction X, and a bent portion 62Ma is formed, as illustrated in FIG. 10B.

Since the tube 62Y bends as the development unit 9Y moves from the contact position to the separated position, the movement (the pivotal movement) of the development unit 9Y is less likely to be hindered by the tube 62Y. Similarly, since the tube 62M bends as the development unit 9M moves from the contact position to the separated position, the movement (the pivotal movement) of the development unit 9M is less likely to be hindered by the tube 62M.

### Low-Friction Member

The structure of a low-friction member 90 according to the present embodiment is described below. When the tube 62Y moves while sliding against the outer surfaces of the developer container 3Y and developer container 3M, the frictional resistance between the tube 62Y and each of the housing of the developer container 3Y and developer container 3M is to be low. Also, the frictional resistance between the tube 62M and the housing of the development unit 9M is to be low. The housing of the developer container 3Y and the developer container 3M are formed of, for example, acrylonitrile butadiene styrene resin (ABS resin) or polystyrene resin (PS resin). The developer containers 3Y and 3M are formed by injection molding. In contrast, the tubes 62Y and 62M are formed of, for example, polyurethane, silicone, nylon, or polyolefin. According to the present embodiment, the tubes 62Y and 62M are formed by extrusion molding. For this reason, the coefficient of static friction of the outer peripheral surfaces of the tubes 62Y and 62M tends to increase. Therefore, when the tubes 62Y and 62M are brought into contact with the outer surface of the developer container 3Y or the outer surface of the developer container 3M, the frictional resistance therebetween tends to increase, and the movement of the development units 9Y and 9M may be hindered. Therefore, according to the present embodiment, a low-friction member 90M (a first low-friction member, first attachment, first holding member) is attached to a portion 62Yb (a third portion), which is part of the outer peripheral surface of the tube 62Y, and a portion 62Mb (a first portion), which is part of the outer peripheral surface of tube 62M. This is to prevent the portion 62Yb of the tube 62Y and the portion 62Mb of the tube 62M from being brought into contact with a portion 3Ma (a second portion), which is part of the outer surface of the developer container 3M. Similarly, a low-friction member 90Y is attached to a portion of the outer peripheral surface of tube 62Y. This is to prevent the tube 62Y from being brought into contact with the outer surface of the developer container 3Y.

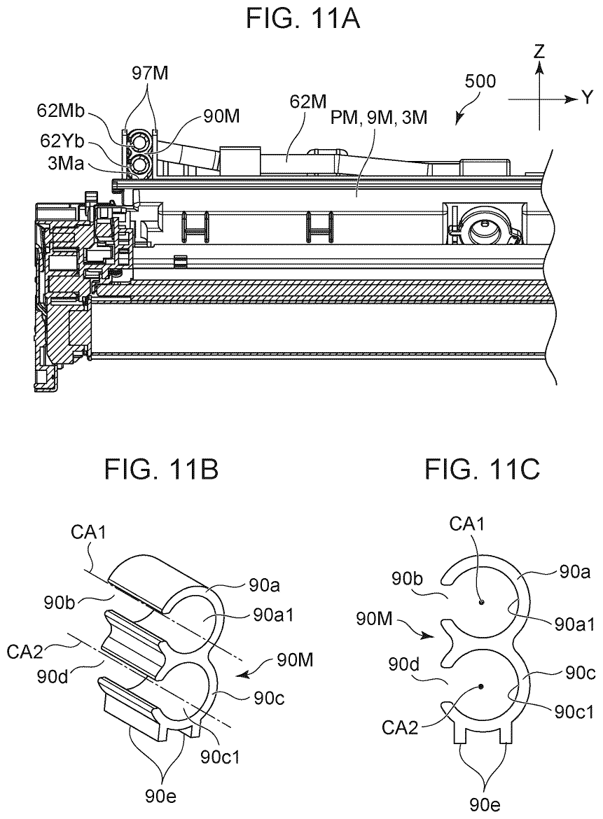

The low-friction member 90Y and the low-friction member 90M (hereinafter collectively referred to as a “low-friction member 90”) are formed of, for example, polyacetal resin (POM resin), ABS resin, polycarbonate resin (PC resin), or polycarbonate ABS (PC ABS resin). The low-friction member 90 is formed by injection molding. FIG. 11A is a cross-sectional view of the image forming unit 500 that is taken perpendicular to the first direction X to pass through the portion 62Yb of the tube 62Y and the portion 62Mb of the tube 62M. The first direction X is the direction in which the portion 62Yb of the tube 62Y and the portion 62Mb of the tube 62M extend. FIG. 11B is a perspective view of the low-friction member 90M, and FIG. 11C is a front view of the low-friction member 90M as viewed in the first direction X. As illustrated in FIGS. 11A, 11B, and 11C, the low-friction member 90M has a first surrounding portion 90a (a first holding portion) having a first inner peripheral surface 90a1 that surrounds the portion 62Yb of the tube 62Y from the outside and that is centered on a central axis CA1. The low-friction member 90M includes a second surrounding portion 90c (a second holding portion) having a second inner peripheral surface 90c1 that surrounds the portion 62Mb of the tube 62Y from the outside and that is centered on a central axis CA2. The first surrounding portion 90a and the second surrounding portion 90c are integrally formed. The low-friction member 90M has a first open portion 90b (a first opening), which is a portion of the first inner peripheral surface 90a1 excluding the first surrounding portion 90a in the circumferential direction, and a second open portion 90d (a second opening), which is a portion of the second inner peripheral surface 90c1 excluding the second surrounding portion 90c in the circumferential direction. The portion 62Yb of the tube 62Y is press-fit inserted from the first open portion 90b of the low-friction member 60M into the inner side of the first inner peripheral surface 90a1 of the first surrounding portion 90a. Similarly, the portion 62Mb of the tube 62M is press-fit inserted from the second open portion 90d of the low-friction member 60M to the inner side of the second inner peripheral surface 90c1 of the second surrounding portion 90c.

The coefficient of static friction of the leg portions 90e, which are the outer surfaces of the low-friction member 90M that can be in contact with the portion 3Ma of the developer container 3M is lower than that of the portion 62Yb of the tube 62Y and the portion 62Mb of the tube 62M. Therefore, when the tube 62Y moves relative to the developer container 3M as the development unit 9Y moves from the contact position to the separated position, the leg portions 90e of the low-friction member 90M slide against the portion 3Ma of the developer container 3M. Thus, the tube 62Y can move smoothly relative to the developer container 3M. Similarly, when the portion 62Mb of the tube 62M moves relative to the developer container 3M, the low-friction member 90M slides against the portion 3Ma of the developer container 3M. Thus, the tube 62M can move smoothly relative to the development unit 9M. Furthermore, the low-friction member 90M holds the portion 62Yb of the tube 62Y and the portion 62Mb of the tube 62M in the first surrounding portion 90a and the second surrounding portion 90c, respectively, so that the portion 62Yb and the portion 62Mb do not come into contact with each other. Therefore, the movement of the development units 9Y and 9M between the contact position and the separated position is less likely to be hindered by the tubes 62Y and 62M.

A regulating portion 95Y illustrated in FIG. 10A protrudes upward from the upper surface of the developer container 3Y. The regulating portion 95Y regulates the movement of the tube 62Y in the-X direction so that the tube 62Y does not move in the-X direction on the upper surface of the developer container 3Y and does not block a light path LY. Similarly, a regulating portion 95M protrudes upward from the upper surface of the developer container 3M. The regulating portion 95M regulates the movement of the tube 62M in the-X direction so that the tube 62M does not move in the-X direction on the upper surface of the developer container 3M and does not block a light path LM. When the development unit 9Y moves from the contact position to the separated position, the tube 62Y is subjected to a force in the +X direction from the regulating portion 95Y. When the development unit 9M moves from the contact position to the separated position, the tube 62M is subjected to a force in the +X direction from the regulating portion 95M.

A pair of regulating portions 97Y protrude upward from the upper surface of the developer container 3Y, and the two regulating portions 97Y are aligned in the second direction Y to sandwich the low-friction member 90Y. Movement of the tube 62Y in the second direction Y is regulated by the regulating portions 97Y. The direction in which the development unit 9Y moves between the contact position and the separated position is the first direction X as viewed in the third direction Z. However, since the spacing in the second direction Y of the two regulating portions 97Y is greater than the width in the second direction Y of the low-friction member 90Y, the two regulating portions 97Y can move smoothly in the first direction X relative to the low-friction member 90Y. Therefore, the pair of regulating portions 97Y is less likely to hinder the movement of the development unit 9Y. Similarly, the pair of regulating portions 97M protrude upward from the upper surface of the developer container 3M, and the two regulating portions 97M are aligned in the second direction Y to sandwich the low-friction member 90M. Movement of the tube 62Y in the second direction Y is regulated by the regulating portions 97M. The spacing in the second direction Y of the pair of regulating portions 97M is greater than the width in the second direction Y of the low-friction member 90M. Therefore, the pair of regulating portions 97M can move smoothly in the first direction X relative to the low-friction member 90M.

### Second Embodiment

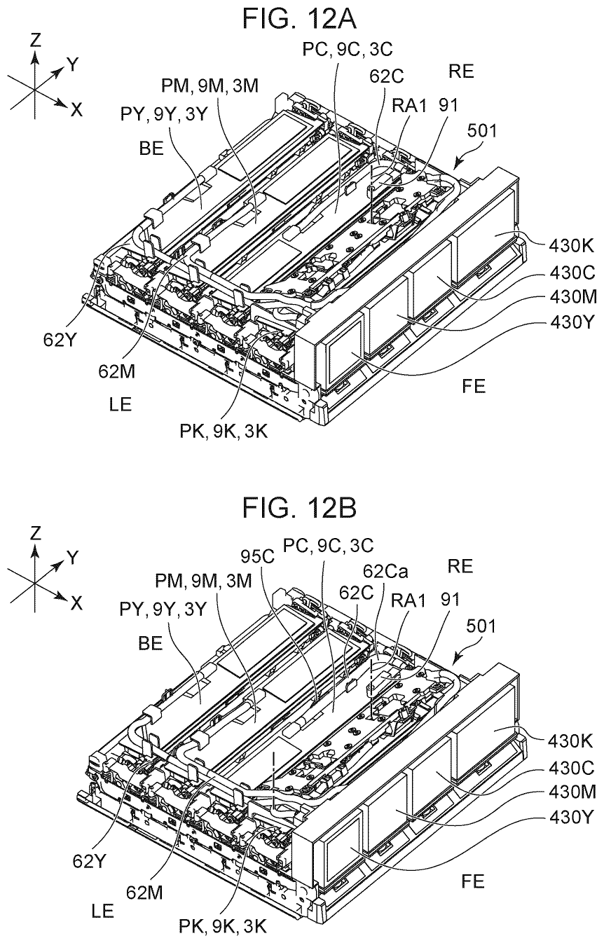

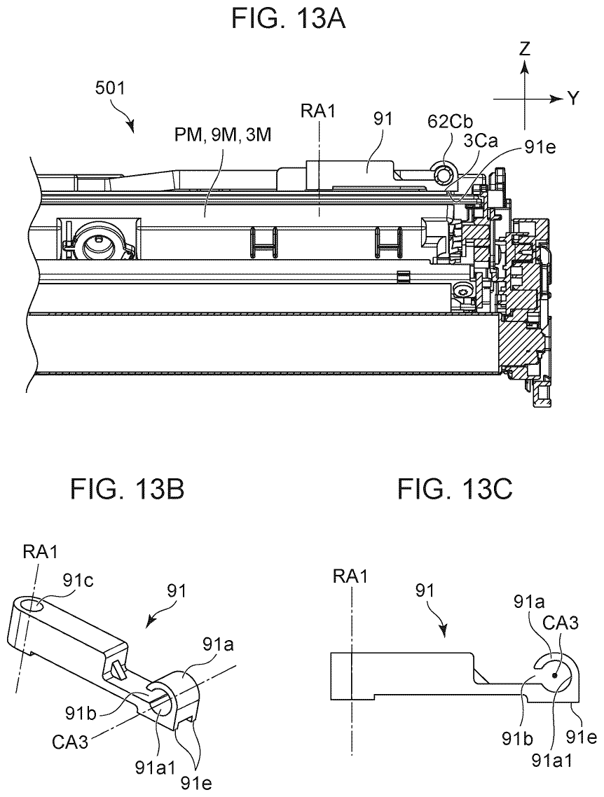

The structure of a low-friction member 91 according to the present embodiment is described below. FIG. 12A is a perspective view of an image forming unit 501 including photosensitive drums 4 and development rollers 6, each in contact with a corresponding one of the photosensitive drums 4. FIG. 12B is a perspective view of the image forming unit 501 including photosensitive drums 4 and development rollers 6, each separated from a corresponding one of the photosensitive drums 4. The low-friction member 91 is attached to a portion 62Cb, which is part of the outer peripheral surface of the tube 62C, so that the portion 62Cb and a portion 3Ca, which is part of the outer surface of the development unit 9C (the developer container 3Y), are not brought into contact with each other. FIG. 13A is a cross-sectional view of the image forming unit 501 that is taken perpendicular to the first direction X and through the portion 62Cb of the tube 62C. FIG. 13B is a perspective view of the low-friction member 91, and FIG. 13C is a front view of the low-friction member 91 as viewed in the first direction X. When the tube 62C moves relative to the outer surface of the developer container 3C of the development unit 9C as the development unit 9C moves between the contact position and the separated position, the frictional resistance between the tube 62C and the development unit 9C is to be low. Therefore, according to the present embodiment, the low-friction member 91 is provided in the portion 62Cb of the tube 62C. The low-friction member 91 is formed of, for example, POM resin, acrylonitrile butadiene styrene resin (ABS resin), PC resin, or polycarbonate ABS (PC/ABS resin). The low-friction member 91 is formed by injection molding.

As illustrated in FIGS. 13A to 13C, the low-friction member 91 has a surrounding portion 91a (a holding portion) having an inner peripheral surface 91a1 that surrounds the portion 62Cb of the tube 62C from the outside and is centered on a central axis CA3. The low-friction member 91 includes an open portion 91b, which is a portion of the inner peripheral surface 91a1 excluding the surrounding portion 91a in the circumferential direction, and a supported portion 91c that is supported on the upper surface of the developer container 3C in a rotatable manner about a rotational axis RA1. The surrounding portion 91a is provided at one end of the low-friction member 91 in the longitudinal direction. The supported portion 91c is provided at the other end of the low-friction member 91 in the longitudinal direction. The portion 62Cb of the tube 62C is press-fit inserted from the open portion 91b into the inner peripheral surface 91a1 of the low-friction member 91. The rotational axis RA1 of the low-friction member 91 extends in the third direction Z, and the central axis CA3 extends in the first direction X. That is, the rotational axis RA1 and the central axis CA3 extend in mutually perpendicular directions. When the development unit 9C moves between the contact position and the separated position, the low-friction member 91 rotates about the rotational axis RA1 with the portion 62Cb of the tube 62Y being held by the surrounding portion 91a. When the low-friction member 91 is rotated, a bottom portion 91e of the low-friction member 91 slides against the portion 3Ca of the developer container 3Y, enabling the tube 62C to move smoothly against the developer container 3C. According to the present embodiment, while the low-friction member 91 is provided in the developer container 3C, the low-friction member 91 may be provided in each of the developer containers 3Y, 3M, and 3K.

### Third Embodiment

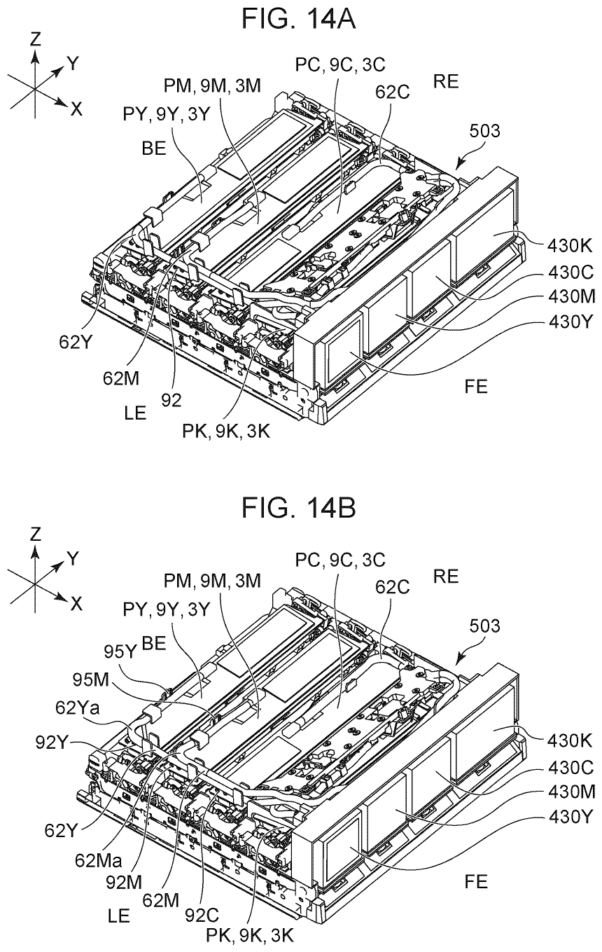

The present embodiment uses a roller 92 (a rotating element) instead of the low-friction member used in the first and second embodiments. FIG. 14A is a perspective view of an image forming unit 503 including photosensitive drums 4 and development rollers 6, each in contact with a corresponding one of the photosensitive drums 4. FIG. 14B is a perspective view of the image forming unit 503 including photosensitive drums 4 and development rollers 6, each separated from a corresponding one of the photosensitive drums 4. A roller 92Y, a roller 92M, and a roller 92C are provided to be rotatable relative to the upper surface of the developer container 3Y, the upper surface of the developer container 3M, and the upper surface of the developer container 3C, respectively. A portion of the tube 62Y extending in the first direction X is in contact with the roller 92Y, the roller 92M, and the roller 92C. When the development unit 9Y is moved in the direction of separation (+X direction) from the contact position to the separated position, the tube 62Y bends while moving relative to the developer container 3Y, the developer container 3M, and the developer container 3C. At this time, since the roller 92Y, the roller 92M, and the roller 92C rotate, the tube 62Y can move smoothly relative to the developer containers 3Y, 3M, and 3C. Therefore, the movement of the tube 62Y relative to the developer container 3 is less likely to interfere with the movement of the development unit 9.

According to the present disclosure, the configuration of an existing image forming apparatus can be further expanded.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-158770, filed Sep. 13, 2024, which is hereby incorporated by reference herein in its entirety.

What is claimed is:

1. An image forming apparatus comprising:
a toner container configured to contain toner, wherein the toner container has a discharging port through which the toner is discharged; and
an apparatus body including a body frame configured for detachable mounting of the toner container on the body frame, wherein the body frame has a communication port that communicates with the discharging port,
wherein the apparatus body includes:
(i) a drum unit including a photosensitive drum,
(ii) a development unit including a developing frame provided with a receiving inlet for receiving the toner, wherein the developing frame includes a storage portion that stores the toner, and a development roller configured to bear the toner stored in the storage portion and supply the toner to the photosensitive drum, wherein the development unit is configured to be movable relative to the photosensitive drum and the body frame between a contact position where the development roller is in contact with the photosensitive drum in the drum unit and a separated position where the development roller is separated from the photosensitive drum, and
(iii) a passage through which the toner discharged from the discharging port of the toner container passes when the toner is conveyed from the communication port to the receiving inlet, wherein the passage has a first end connected to the body frame to communicate with the communication port and a second end connected to the development unit to communicate with the receiving inlet and extends from the first end to the second end, and
wherein the passage comprises a flexible tube and is configured to bend between the first end and the second end as the development unit is moved between the contact position and the separated position.

2. The image forming apparatus according to claim 1, wherein part of an outer peripheral surface of the flexible tube is provided as a first portion, and part of the outer surface of the developing frame is provided as a second portion,
wherein the apparatus body includes a low-friction member attached to the first portion of the flexible tube, and
wherein at least an outer surface of the low-friction member contactable with the second portion of the developing frame has a coefficient of static friction that is lower than a coefficient of static friction of the first portion of the flexible tube.

3. The image forming apparatus according to claim 2, wherein the low-friction member has an inner peripheral surface that surrounds the first portion of the flexible tube, the low-friction member extending perpendicular to a direction in which the flexible tube extends, passing through the first portion of the flexible tube, and
wherein the first portion of the flexible tube is press-fit inserted into the inside of the inner peripheral surface of the low-friction member.

4. The image forming apparatus according to claim 2, wherein the low-friction member is configured to be move relative to the developing frame while holding the first portion of the flexible tube.

5. The image forming apparatus according to claim 4, wherein the low-friction member has a holding portion configured to hold the first portion of the flexible tube at one end portion in a longitudinal direction and has a supported portion that is supported in a movable manner relative to the developing frame at the other end portion in the longitudinal direction.

6. The image forming apparatus according to claim 5, wherein the supported portion of the low-friction member is supported by the developing frame so that the low-friction member is rotatable about a rotational axis relative to the developing frame.

7. The image forming apparatus according to claim 6, wherein the low-friction member has an inner peripheral surface that surrounds the first portion of the flexible tube, the low-friction member extending perpendicular to a direction in which the flexible tube extends, passing through the first portion of the flexible tube, and
wherein a central axis of the inner peripheral surface of the low-friction member extends in a direction that intersects the rotational axis.

8. The image forming apparatus according to claim 1, wherein the toner container, the discharging port, the communication port, the receiving inlet, the storage portion, the developing frame, the development roller, the photosensitive drum, the drum unit, the development unit, the contact position, the separated position, and the flexible tube are provided as a first toner container, a first discharging port, a first communication port, a first receiving inlet, a first storage portion, a first developing frame, a first development roller, a first photosensitive drum, a first drum unit, a first development unit, a first contact position, a first separated position, and a first tube, respectively,
wherein the image forming apparatus further includes a second toner container configured to store toner, wherein the second toner container has a second discharging port and is detachably mountable in the body frame,
wherein the body frame has a second communication port that communicates with the second discharging port,
wherein the apparatus body further includes:
(i) a second drum unit including a second photosensitive drum,
(ii) a second development unit including a second developing frame having a second receiving inlet for receiving the toner, wherein the second developing frame includes a second storage portion that stores the toner, and a second development roller configured to bear the toner stored in the second storage portion and supply the toner to the second photosensitive drum, wherein the second development unit is configured to be move relative to the second photosensitive drum and the body frame between a second contact position where the second development roller is in contact with the second photosensitive drum in the second drum unit and a second separated position where the second development roller is separated from the second photosensitive drum, and
(iii) a flexible second tube, wherein the flexible second tube has a third end portion connected to the body frame to communicate with the second communication port and a fourth end portion connected to the second development unit to communicate with the second receiving inlet, and the toner discharged from the second discharging port passes through the flexible second tube when being conveyed from the second communication port to the second receiving inlet, and
wherein the flexible second tube is configured to bend between the third end portion and the fourth end portion as the second development unit is moved between the second contact position and the second separated position.

9. The image forming apparatus according to claim 8, wherein part of an outer peripheral surface of the first tube, part of an outer surface of the first developing frame, part of an outer surface of the flexible second tube are provided as a first portion, a second portion, and a third portion, respectively,
wherein the apparatus body includes a low-friction member attached to both the first portion of the first tube and the third portion of the flexible second tube, and
wherein at least an outer surface of the low-friction member contactable with the second portion of the first developing frame has a lower coefficient of static friction than both the first portion of the first tube and the third portion of the flexible second tube.

10. The image forming apparatus according to claim 9, wherein the low-friction member includes:
a first surrounding portion that surrounds the first portion of the first tube, extending in a direction in which the first tube extends and passing through the first portion of the first tube, and
a second surrounding portion that surrounds the third portion of the flexible second tube, extending in a direction in which the flexible second tube extends and passing through the third portion of the flexible second tube.

11. The image forming apparatus according to claim 10, wherein the first surrounding portion and the second surrounding portion are integrally formed.

12. The image forming apparatus according to claim 1, wherein the apparatus body includes a roller supported by the developing frame and rotatable relative to the developing frame.

13. The image forming apparatus according to claim 12, wherein the roller is configured to rotate in a direction in which the flexible tube is moved relative to the developing frame as the development unit is moved between the contact position and the separated position.

14. The image forming apparatus according to claim 1, wherein the flexible tube is formed of at least one of polyurethane, silicone, nylon, and polyolefin.
